(19) United States
(12) Patent Application Publication
(10) Pub. No.: US 2012/0132851 A1
(43) Pub. Date: May 31, 2012

(54) MAT OF MINERAL FIBERS INCLUDING AN AGENT CAPABLE OF TRAPPING FORMALDEHYDE AND MANUFACTURING PROCESSES

(75) Inventors: Benjamin Blanchard, Taverny (FR); Katarzyna Chuda, Villejuif (FR); Boris Jaffrennou, Paris (FR)

(73) Assignee: Saint-Gobain Adfors, Chambery (FR)

(21) Appl. No.: 13/375,992

(22) PCT Filed: Jun. 2, 2010
(86) PCT No.: PCT/FR2010/051073

§ 371 Date: Jan. 13, 2012

(30) Foreign Application Priority Data
Jun. 3, 2009 (FR) 0953654

(51) Int. Cl. C09K 3/00; D01F 11/00

(52) U.S. Cl. 252/182.12; 252/182.11; 264/211

(57) ABSTRACT

The present invention relates to a mat of mineral fibers which comprises an agent capable of trapping formaldehyde present in particular in dwellings or offices and transportation vehicles.

The agent capable of trapping formaldehyde is chosen from compounds comprising active methylene(s), hydrazides, tannins, amides, amino acids and sulfites.

Another subject matter of the present invention is the processes for the manufacture of said mat of mineral fibers.

The invention relates to a mat of mineral fibers which includes an agent capable of trapping formaldehyde and to the processes which allow it to be manufactured.

Highly varied composite materials are used in the field of the construction and fitting out of dwellings and offices, and also of transportation vehicles. Some of these materials, such as sound and/or thermal insulators, wooden panels, furniture parts and decorative parts, use adhesives, paints and varnishes comprising formaldehyde-based resins.

The proportion of formaldehyde in these materials is already very low. However, regulations regarding protection against undesirable emissions of products, such as formaldehyde, which may exhibit a risk to the health of the individual are becoming stricter and require a further reduction in the amount of free formaldehyde or formaldehyde capable of being emitted by materials over time.

Means for reducing the content of formaldehyde inside buildings are known.

The proposal has been made to include particles of photocatalytic titanium oxide in a paint or material made of plaster (US-A-2005/0226761), a paper or a textile, plastic or wooden material (EP-A-1 437 397).

It is also known to use a hydrazide in a construction material based on plaster or on cement (US-A-2004/0101695 and JP-A-2004115340).

It is also known to use a carbodihydrazide in a fiberboard for capturing and decomposing formaldehyde and acetaldehyde (EP 1 905 560).

The aim of the present invention is to reduce the amount of formaldehyde present inside buildings, in particular dwellings, and transportation vehicles.

To achieve this aim, the present invention provides a mat of mineral fibers which comprises an agent capable of trapping formaldehyde.

Another subject matter of the invention is the processes which allow said mat of mineral fibers to be manufactured.

The term “compound capable of reacting with formaldehyde” is understood to mean an organic compound which bonds to formaldehyde via a covalent bond.

Preferably, the compound capable of reacting with formaldehyde is chosen from:

1—compounds comprising active methylene(s), preferably corresponding to the following formulae:

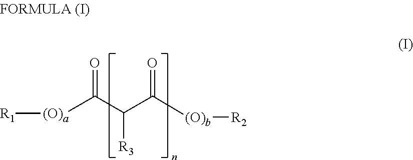

in which:
R₁ and R₂, which are identical or different, represent a hydrogen atom, a C₁-C₂₀, preferably C₁-C₆, alkyl radical, an amino radical or a radical of formula

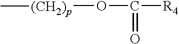

in which R₄ represents a

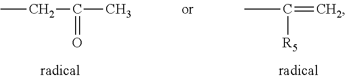

where R₅=H or —CH₃, and p is an integer varying from 1 to 6,
R₃ represents a hydrogen atom, a C₁-C₁₀ alkyl radical, a phenyl radical or a halogen atom,
a is equal to 0 or 1,
b is equal to 0 or 1,
n is equal to 1 or 2.

The preferred compounds of formula (I) are:
2,4-pentanedione:
   R₁=—CH₃; R₂=—CH₃; R₃=H; a=0; b=0; n=1
2,4-hexanedione:
   R₁=—CH₂—CH₃; R₂=—CH₃; R₃=H; a=0; b=0; n=1
3,5-heptanedione:
   R₁=—CH₂—CH₃; R₂=—CH₂—CH₃; R₃=H; a=0; b=0; n=1
2,4-octanedione:
   R₁=—CH₃; R₂=—(CH₂)₃—CH₃; R₃=H; a=0; b=0; n=1
acetoacetamide:
   R₁=—CH₃; R₂=—NH₂; R₃=H; a=0; b=0; n=1
acetoacetic acid:
   R₁=—CH₃; R₂=H; R₃=H; a=0; b=1; n=1
methyl acetoacetate:
   R₁=—CH₃; R₂=—CH₃; R₃=H; a=0; b=1; n=1
ethyl acetoacetate:
   R₁=—CH₃; R₂=—CH₂—CH₃; R₃=H; a=0; b=1; n=1
n-propyl acetoacetate:
   R₁=—CH₃; R₂=—(CH₂)₂—CH₃; R₃=H; a=0; b=1; n=1
isopropyl acetoacetate:
   R₁=—CH₃; R₂=—CH(CH₃)₂; R₃=H; a=0; b=1; n=1
isobutyl acetoacetate:
   R₁=—CH₃; R₂=—CH₂—CH(CH₃)₂; R₃=H; a=0; b=1; n=1
t-butyl acetoacetate:
   R₁=—CH₃; R₂=—C(CH₃)₃; R₃=H; a=0; b=1; n=1
n-hexyl acetoacetate:
   R₁=—CH₃; R₂=—(CH₂)₅—CH₃; R₃=H; a=0; b=1; n=1
malonamide:
   R₁=—NH₂; R₂=—NH₂; R₃=H; a=0; b=0; n=1
malonic acid:
   R₁=H; R₂=H; R₃=H; a=1; b=1; n=1
dimethyl malonate:
   R₁=—CH₃; R₂=—CH₃; R₃=H; a=1; b=1; n=1
diethyl malonate:
   R₁=—CH₂—CH₃; R₂=—CH₂—CH₃; R₃=H; a=1; b=1; n=1
di(n-propyl) malonate:
   R₁=—(CH₂)₂—CH₃; R₂=—(CH₂)₂—CH₃; R₃=H; a=1; b=1; n=1
diisopropyl malonate:
   R₁=—CH(CH₃)₂; R₂=—CH(CH₃)₂; R₃=H; a=1; b=1; n=1
di(n-butyl)malonate:
   R₁=—(CH₂)₃—CH₃; R₂=—(CH₂)₃—CH₃; R₃=H; a=1; b=1; n=1
acetonedicarboxylic acid:
   R₁=H; R₂=H; R₃=H; a=1; b=1; n=2
dimethyl acetonedicarboxylate:
   R₁=—CH₃; R₂=—CH₃; R₃=H; a=1; b=1; n=2
1,4-butanediol diacetate:
   R₁=—CH₃; R₂=—(CH₂)₄—O—CO—CH₂—CO—CH₃; R₃=H; a=0; b=1; n=1
1,6-hexanediol diacetate:
   R₁=—CH₃; R₂=—(CH₂)₆—O—CO—CH₂—CO—CH₃; R₃=H; a=0; b=1; n=1
methacryloyloxyethyl acetoacetate:
   R₁=—CH₃; R₂=—(CH₂)₂—O—CO—C(CH₃)═CH₂; R₃=H; a=0; b=1; n=1

FORMULA (II)

R₆—CHR₇—C≡N (II)

in which:
R₆ represents a cyano radical or a

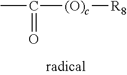

in which:
R₈ represents a hydrogen atom, a C₁-C₂₀, preferably C₁-C₆, alkyl radical or an amino radical
c is equal to 0 or 1
R₇ represents a hydrogen atom, a C₁-C₁₀ alkyl radical, a phenyl radical or a halogen atom.

The preferred compounds of formula (II) are:
methyl 2-cyanoacetate:
   R₆=—CO—O—CH₃; R₇=H
ethyl 2-cyanoacetate:
   R₆=—CO—O—CH₂—CH₃; R₇=H
n-propyl 2-cyanoacetate:
   R₆=—CO—O—(CH₂)₂—CH₃; R₇=H
isopropyl 2-cyanoacetate:
   R₆=—CO—O—CH(CH₃)₂; R₇=H
n-butyl 2-cyanoacetate:
   R₆=—CO—O—(CH₂)₃CH₃; R₇=H
isobutyl 2-cyanoacetate:
   R₆=—CO—O—CH₂—CH(CH₃)₂; R₇=H
tert-butyl 2-cyanoacetate:
   R₆=—CO—O—C(CH₃)₃; R₇=H
2-cyanoacetamide:
   R₆=—CO—NH₂; R₅=H
propanedinitrile:
   R₆=—C≡N; R₅=H

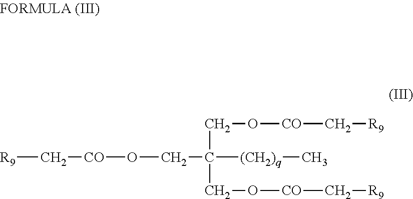

in which:
R₉ represents a —C≡N or —CO—CH₃ radical
q is an integer varying from 1 to 4.

The preferred compounds of formula (III) are:
trimethylolpropane triacetoacetate:
   R₉=—CO—CH₃; q=1
trimethylolpropane tricyanoacetate:
   R₉=—C≡N; q=1

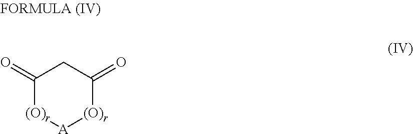

in which:
A represents a —(CH₂)₃— or —C(CH₃)₂— radical
r is equal to 0 or 1.

The preferred compounds of formula (IV) are:
1,3-cyclohexanedione:
   A=—(CH₂)₃—; r=0
Meldrum's acid:
   A=—C(CH₃)₂—; r=1.

2—hydrazides, for example:

a) monohydrazides of formula R₁CONHNH₂ in which R₁ represents an alkyl radical, for example a methyl, ethyl, n-propyl, isopropyl, n-butyl, sec-butyl or tert-butyl radical, or an aryl radical, for example a phenyl, biphenyl or naphthyl radical, it being understood that a hydrogen atom of said alkyl or aryl radicals can be replaced by a hydroxyl group or a halogen atom and said aryl radical can be substituted by an alkyl radical, for example a methyl, ethyl or n-propyl radical,

b) dihydrazides of formula H₂NHN—X—NHNH₂ in which X represents a —CO— or —CO—Y—CO— radical, and Y is an alkylene radical, for example a methylene, ethylene or trimethylene radical, or an arylene radical, for example a phenylene, biphenylene or naphthylene radical, it being understood that a hydrogen atom of said alkylene or arylene radicals can be replaced by a hydroxyl group or a halogen atom and said aryl radical can be substituted by an alkyl radical, for example a methyl, ethyl or n-propyl radical. Mention may be made, by way of examples, of oxalic acid dihydrazide, malonic acid dihydrazide, succinic acid dihydrazide, adipic acid dihydrazide, sebacic acid dihydrazide, maleic acid dihydrazide, fumaric acid dihydrazide, diglycolic acid dihydrazide, tartaric acid dihydrazide, malic acid dihydrazide, isophthalic acid dihydrazide, terephthalic acid dihydrazide and carbohydrazide,

c) polyhydrazides, such as trihydrazides, in particular citric acid trihydrazide, pyromellitic acid trihydrazide, 1,2,4-benzenetrihydrazide, nitrilo-triacetic acid trihydrazide and cyclohexane-tricarboxylic acid trihydrazide, tetrahydrazides, in particular ethylenediaminetetraacetic acid tetrahydrazide or 1,4,5,8-naphthoic acid tetrahydrazide, and polyhydrazides formed from a hydrazide monomer comprising a polymerizable group, for example a poly(acrylic acid hydrazide) or a poly(methacrylic acid hydrazide).

3—tannins, in particular condensed tannins, such as mimosa, quebracho, pine, pecan nut, hemlock wood and sumac tannins.

4—amides, for example urea, 1,3-dimethylurea, ethyleneurea and its derivatives, such as N-hydroxyethyleneurea, N-aminoethylethyleneurea, N-(3-allyloxy-2-hydroxypropyl)aminoethylethyleneurea, N-acryloxyethylethyleneurea, N-methacryloxyethyl-ethyleneurea, N-acrylaminoethylethyleneurea, N-methacrylaminoethylethyleneurea, N-methacryloyloxy-acetoxyethyleneurea, N-methacryloyloxyacetaminoethyl-ethyleneurea and N-di(3-allyloxy-2-hydroxypropyl)amino-ethylethyleneurea, diurea, biuret, triuret, acrylamide, methacrylamide, polyacrylamides and polymethacrylamides,

5—amino acids, in particular glycine,

6—sulfites, for example ammonium, potassium or sodium bisulfite, and alkali metal, in particular sodium, or alkaline earth metal metabisulfites.

The amount of agent capable of trapping formaldehyde to be used can vary to a large extent, for example from 0.1 to 500 g/m² of mat, preferably from 0.5 to 100 g/m² and advantageously from 1 to 50 g/m².

If appropriate, the agent capable of trapping formaldehyde can be used in combination with at least one porous material which adsorbs volatile organic compounds, in particular aromatic compounds, such as xylene, benzene and toluene.

This porous material is provided in the form of particles having a size which varies from 10 nm to 100 μm, preferably from 500 nm to 50 μm and advantageously from 1 to 10 μm. Preferably, the particles exhibit a specific surface which varies from 1 to 5000 m²/g, advantageously from 5 to 2000 m²/g, in particular of greater than 100 m²/g, and at mean pore diameter varying from 1 to 50 nm, preferably from 1 to nm.

The porous material can be:
pyrogenic or nonpyrogenic, precipitated or nonprecipitated and microporous or mesoporous silica which can comprise nanoparticles of metal complexes of oxides, of hydroxides, of hydrates or of polyoxometalates,
a carbon black which can comprise nanoparticles of metal complexes of oxides, of hydroxides, of hydrates or of polyoxometalates,
an activated aluminum oxide and potassium permanganate,
a natural or synthetic zeolite,
a polymer, for example a polyamide.

The mat in accordance with the invention is based on mineral fibers and can optionally comprise fibers composed of an organic material, for example an olefin, such as polyethylene and polypropylene, or a polyalkylene terephthalate, such as polyethylene terephthalate.

The term “fibers” is understood to mean both filaments and yarns composed of a multitude of filaments bonded together, in particular by a size, and the assemblies of such yarns.

The mineral material constituting the above-mentioned fibers is preferably a glass or a rock, in particular a basalt.

Thus, according to a first embodiment, the mat of mineral fibers is composed of discontinuous mineral filaments which have a length which can reach 150 mm, preferably varying from 20 to 100 mm and advantageously from 50 to 70 mm, and which have a diameter which can vary within wide limits, for example from 5 to 30 μm.

According to a second embodiment, the mat of mineral fibers is composed of mineral fibers.

The mineral yarns can be yarns composed of a multitude of mineral filaments (or base yarns) or assemblies of these base yarns in the form of rovings, “commingled” yarns composed of mineral filaments and of filaments of the abovementioned organic material which are intimately mixed, or mixed yarns comprising at least one yarn composed of a multitude of mineral filaments and at least one yarn composed of a multitude of filaments of the abovementioned thermoplastic organic material.

The abovementioned yarns can be twist-free yarns or twisted yarns (or textile yarns), preferably twist-free yarns.

The mineral yarns, in particular glass yarns, are generally cut to a length which can range up to 100 mm, preferably varying from 6 to 30 mm, advantageously from 8 to 20 mm and better still from 10 to 18 mm.

The diameter of the glass filaments constituting the yarns can vary to a large extent, for example from 5 to 30 μm. In the same way, wide variations can occur in the linear density of the yarn, which can range from 34 to 1500 tex.

The glass participating in the composition of the filaments can be of any type, for example E, C, R or AR (alkali-resistant). The glass E is preferred.

The mat of mineral fibers according to one or other embodiment exhibits a weight per unit area which varies from 10 to 1100 g/m², preferably from 20 to 300 g/m².

The mat of mineral fibers conventionally comprises a binder which bonds said fibers and confers on the mat mechanical properties suited to the desired use, in particular a sufficient stiffness to be able to be easily handled.

The binder generally comprises at least one polymer capable of bonding the mineral fibers. This polymer can be a thermoplastic polymer, for example styrene/acrylonitrile, acrylonitrile/butadiene/styrene, cellulose (tri)acetate, expanded polystyrene, a polyolefin, such as polyethylene and polypropylene, a poly(meth)acrylate, a polyvinyl acetate or a polyoxymethylene; a thermosetting polymer, for example an unsaturated polyester, an epoxide, a phenolic resin, such as a novolac or a resol, in particular having a level of free aldehyde(s) of less than 0.05%, a polyimide, a polyurethane, a phenoplast or a biopolymer, for example a polysaccharide or a protein; an elastomeric polymer, for example a fluoropolymer, in particular based on vinylidene fluoride, neoprene, a polyacrylic, a polybutadiene, a poly(ether amide), a silicone, a natural or styrene/butadiene (SBR) rubber, or a biopolymer, for example a polysaccharide or a protein.

The binder generally represents from 1 to 1000% by weight of the mat of mineral fibers, preferably from 5 to 350% and advantageously from 10 to 100%.

The processes for the manufacture of the mat of mineral fibers and of the mat of mineral yarns constitute other subject matters of the present invention.

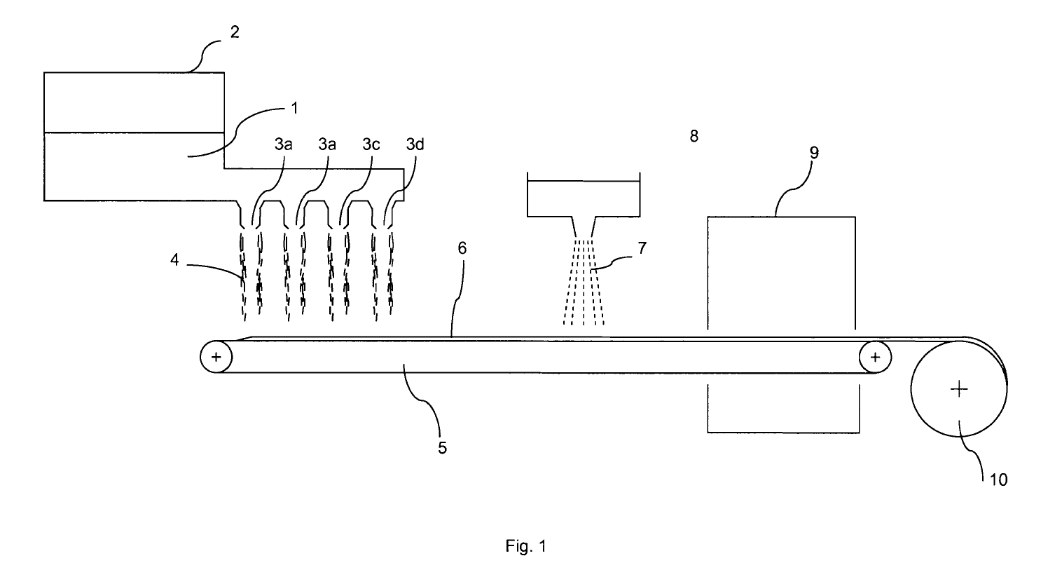

FIG. 1 is a diagrammatic view of a conventional plant which makes possible the manufacture of a mat of mineral filaments according to a “dry” process.

Molten mineral material (1) present in an oven (2) is directed towards a group of several bushings (3a-d), from which filaments (4) flow out by gravity and are drawn by a gaseous fluid. The filaments (4) are collected on a conveyor (5) moving in the direction indicated by the arrow, where they become entangled or in the formation of a mat (6).

A binder (7) is applied to the mat (6) using a device (8) which operates by spraying and then the mat enters a hot air drying device (9), the temperature of which is adjusted in order to remove the water and optionally crosslink the binder.

Other drying devices can be used, for example a device operating by infrared radiation or comprising one or more heating rollers.

At the outlet of the drying device (9), the mat (6) is collected in the form of a winding (10).

In accordance with the invention, a stage of treatment with an agent capable of trapping formaldehyde is added to this conventional plant.

According to a first embodiment, the agent capable of trapping formaldehyde is introduced in the binder (7). This embodiment is preferred as it does not require any additional device for the application of the agent capable of trapping formaldehyde, which is advantageous from an economic viewpoint.

According to a second embodiment, the agent capable of trapping formaldehyde is applied after the binder (7) is deposited on the mat (6) and before the latter enters the drying device (9).

Said agent can be applied by any known means, preferably using a device which operates by spraying.

For example, this device can be composed of a plurality of spray nozzles fed with an aqueous solution of the agent capable of trapping formaldehyde which generate divergent streams which interpenetrate shortly before arriving in contact with the upper face of the mat (6).

The agent capable of trapping formaldehyde can also be applied by uptake, in a stage subsequent to collecting the mat in the form of a winding (10), for example by passing the mat into a bath containing said agent. However, it is more expensive to proceed in this way than in the preceding ways as an additional stage of unwinding the mat and specific means for applying the agent capable of trapping formaldehyde in the form of an aqueous solution and for removing the water are required.

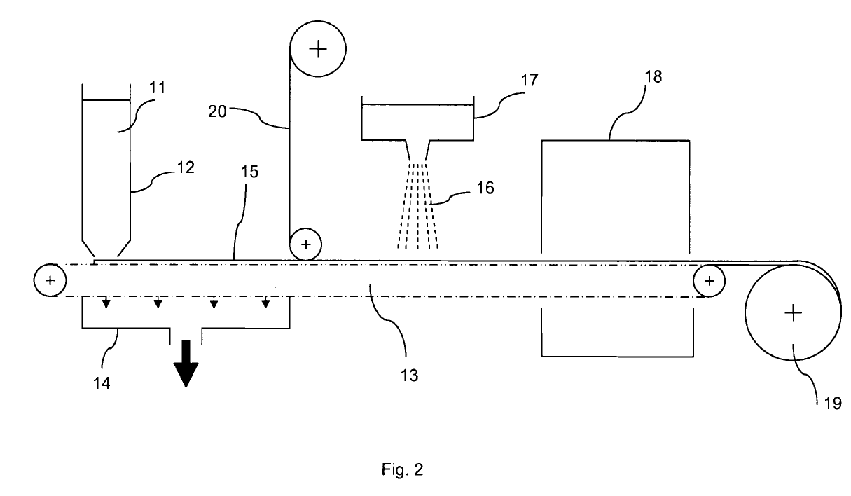

FIG. 2 is a diagrammatic view of a conventional plant which makes it possible to manufacture a mat of mineral fibers according to a “wet” process.

A dispersion of cut mineral yarns in water (11) is deposited by means of a forming head (12) on a conveyor (13) provided with perforations. On contact with the conveyor (13), the water present in the dispersion (11) is extracted by a suction box (14). On the conveyor, the cut mineral yarns form a mat (15) on which a binder (16) is deposited by means of a spraying device (17). The mat (15) subsequently enters a hot air drying device (18), the temperature of which is adjusted in order to remove the residual water and optionally to obtain crosslinking of the binder.

Just as in the “dry” process, the drying device (18) can be replaced by a device operated by infrared radiation or comprising one or more heating rollers.

The mat (15) is subsequently collected in the form of a winding (19).

The mat can, if appropriate, be reinforced with continuous fibers (20) laid in the direction of forward progression of the mat and distributed over all or part of the width of the mat. These fibers (20) are generally deposited on the mat (15) before the application of the binder (16).

The fibers (20) can be synthetic or natural fibers.

Mention may be made, as examples of synthetic fibers, of inorganic fibers, in particular of glass or of rock, such as basalt, and organic fibers, in particular of polyamide, of polyester or of a polyolefin, such as polyethylene and polypropylene. Glass is preferred.

Mention may be made, as examples of natural fibers, of plant fibers, in particular of cotton, of coconut, of sisal, of hemp or of flax, and animal fibers, in particular silk or wool.

In accordance with the invention, a stage of treatment with an agent capable of trapping formaldehyde is added to this conventional plant.

The treatment stage can be carried out under the conditions already set out for the “dry” process, that is to say by introducing the agent capable of trapping formaldehyde in the binder (16), by applying the agent after the binder has been deposited on the mat (15) and before the latter enters the drying device (18), or also by uptake, in a stage subsequent to collecting the mat in the form of a winding (19).

Although the invention is described with respect to formaldehyde, it is likely that the above-mentioned agents capable of trapping this compound are also capable of trapping acetaldehyde.

The mat of mineral fibers in accordance with the present invention can be used in numerous applications, for example as covering, to or not to be painted, which can be applied to walls and/or ceilings, surface or sealing covering for gypsum board or cement board, or surface covering for thermal and/or sound insulation products, such as a mineral wool or a foam intended more particularly for insulation of roofs, or for producing a floor covering, such as a fitted carpet or a vinyl material.

The examples which follow make it possible to illustrate the invention without, however, limiting it.

### EXAMPLES 1 AND 2

### a) Manufacture of the Glass Mat

Two liters of an aqueous solution comprising 250 g of hydroxyethylcellulose (thickener; sold under the reference Natrosol® 250 HHR by Hercules) and 0.3 g of an ethoxylated octadecylamine/octadecylguanidine complex (surface-agent; sold under the reference Aerosol C-61 by Cytec; solids content: 70%) are prepared.

2.54 g of cut yarns (length 8 mm) of glass E ( . . . tex; diameter of the filaments: 13 μm) are added to the abovementioned solution.

The suspension of glass yarns obtained is used in a device which makes it possible to produce a mat. The device comprises a screen surmounted by a box leaktight to liquids and a suction box situated under the screen.

The suspension is deposited in the leaktight box and homogenized by vigorous stirring, and then the suction box is started up so as to remove the water. A mat of glass fibers with dimensions of 30 cm×30 cm and having a weight per surface area of 28.2 g/m² is recovered on the screen.

The mat is immersed for 1 minute in an aqueous solution of a binder comprising an acrylic resin (Acrodur® 950L, sold by BASF) and the agent capable of trapping formaldehyde, namely acetoacetamide (example 1) or adipic acid dihydrazide (example 2).

The excess binder in the mat is removed by suction and then the mat is heated at 210° C. for 1 minute in order to consolidate it.

At the end, the mat includes 5 g/m² of acrylic resin and 2.5 g/m² of agent capable of trapping formaldehyde. It exhibits good dimensional stability and good mechanical strength.

### b) Ability to Trap Formaldehyde

A sample of the mat is placed in a device in accordance with the standard ISO 16000-9, modified in that the specific ventilation flow rate is equal to 1.48 m³/(m²·h) and the load level is equal to 0.27 m²/m³.

1—in a first step, the test chamber of the device is fed for 7 days with a continuous stream of air comprising of the order of 50 μg/m³ of formaldehyde. The amount of formaldehyde in the air entering and departing from the chamber is measured over a period of 7 days and the reduction in the amount of formaldehyde per unit of volume of air is calculated.

The formaldehyde is measured by liquid chromatography (HPLC) under the conditions of the standard ISO 16000-3.

The reduction in the amount of formaldehyde achieved with the mat comprising the agent capable of trapping formaldehyde (examples 1 and 2) is shown in table 1 in comparison with a mat manufactured under the conditions described in section a) not comprising an agent capable of trapping formaldehyde (reference).

TABLE 1

| Reduction in the formaldehyde | | | |
|---|---|---|---|
| (μg/m³) | Ex. 1 | Ex. 2 | Ref. |
| 2 days | 7 | 9 | 4 |
| 3 days | 8 | 11 | 2 |
| 7 days | 8 | 10 | 1 |

2—in a second step, the chamber is fed for 7 days with air not comprising formaldehyde and the amount of formaldehyde present in the air at the outlet of the chamber is measured.

The formaldehyde is measured under the same conditions as in section 1.

The amount of formaldehyde emitted by the mat according to examples 1 and 2 is equivalent to that which is measured when the chamber does not contain any mat. It can be concluded therefrom that the formaldehyde is bonded to the agent capable of trapping formaldehyde in a strong and lasting manner.

1: A mat of mineral fibers, comprising an agent capable of trapping formaldehyde.

2: The mat of claim 1, wherein the agent capable of trapping formaldehyde is at least one selected from the group consisting of a compound comprising at least one active methylene, hydrazide, tannin, amide, amino acid and sulfite.

3: The mat of claim 1, wherein the agent capable of trapping formaldehyde is at least one compound selected from the group consisting of: 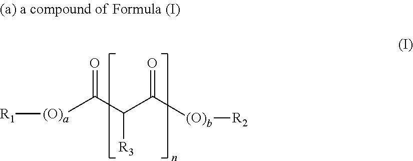
wherein:
R₁ and R₂, which are identical or different, represent a hydrogen atom, a C₁-C₂₀, an alkyl radical, an amino radical or a radical of formula 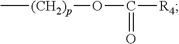
R₄ represents a 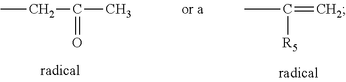
R₅=H or —CH₃;
p is an integer from 1 to 6;
R₃ represents a hydrogen atom, a C₁-C₁₀ alkyl radical, a phenyl radical or a halogen atom;
a is 0 or 1;
b is 0 or 1; and
n is 1 or 2,
(b) a compound of Formula (II)
R₆—CHR₇—C≡N (II)
wherein:
R₆ represents a cyano radical or a 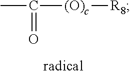
R₈ represents a hydrogen atom, a C₁-C₂₀, preferably C₁-C₆, alkyl radical or an amino radical;
c is 0 or 1; and
R₇ represents a hydrogen atom, a C₁-C₁₀ alkyl radical, a phenyl radical or a halogen atom,
(c) a compound of Formula (III) 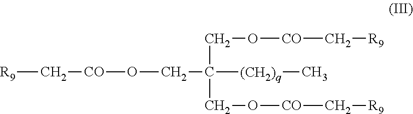
wherein:
R₉ represents a —C≡N or —CO—CH₃ radical; and
q is an integer from 1 to 4, and
(d) a compound of Formula (IV) 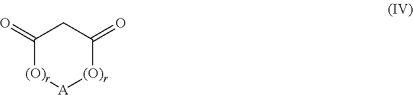
wherein:
A represents a —(CH₂)₃— or —C(CH₃)₂— radical; and
r is 0 or 1.

4: The mat of claim 1, wherein the agent capable of trapping formaldehyde is at least one selected from the group consisting of 2,4-pentanedione, 2,4-hexanedione, 3,5-heptanedione, 2,4-octanedione, acetoacetamide, acetoacetic acid, methyl acetoacetate, ethyl acetoacetate, n-propyl acetoacetate, isopropyl acetoacetate, isobutyl acetoacetate, t-butyl acetoacetate, n-hexyl acetoacetate, malonamide, malonic acid, dimethyl malonate, diethyl malonate, di(n-propyl)malonate, diisopropyl malonate, di(n-butyl)malonate, acetonedicarboxylic acid and dimethyl acetonedicarboxylate.

5: The mat of claim 1, wherein the agent capable of trapping formaldehyde is at least one selected from the group consisting of methyl 2-cyanoacetate, ethyl 2-cyanoacetate, n-propyl 2-cyanoacetate, isopropyl 2-cyanoacetate, n-butyl 2-cyanoacetate, isobutyl 2-cyanoacetate, tert-butyl 2-cyanoacetate, 2-cyanoacetamide and propanedinitrile.

6: The mat of claim 1, wherein the agent capable of trapping formaldehyde is at least one selected from the group consisting of trimethylolpropane triacetoacetate and trimethylolpropane tricyanoacetate.

7: The mat of claim 1, wherein the agent capable of trapping formaldehyde is at least one selected from the group consisting of 1,3-cyclohexanedione and Meldrum's acid.

8: The mat of claim 1, wherein the agent capable of trapping formaldehyde is at least one selected from the group consisting of:
(a) a monohydrazide of formula R₁CONHNH₂, wherein R₁ represents an alkyl radical or an aryl radical, optionally replaced by a hydroxyl group or a halogen atom and the aryl radical optionally substituted by an alkyl radical;
(b) a dihydrazide of formula H₂NHN—X—NHNH₂, wherein X represents a —CO— or —CO—Y—CO— radical, and Y represents an alkylene radical or an arylene radical, such that a hydrogen atom of the alkylene radical or the arylene radical is optionally replaced by a hydroxyl group or a halogen atom, and the aryl radical is optionally substituted by an alkyl radical; and
(c) a polyhydrazide.

9: The mat of claim 1, wherein the agent capable of trapping formaldehyde is at least one selected from the group consisting of oxalic acid dihydrazide, malonic acid dihydrazide, succinic acid dihydrazide, adipic acid dihydrazide, sebacic acid dihydrazide, maleic acid dihydrazide, fumaric acid dihydrazide, diglycolic acid dihydrazide, tartaric acid dihydrazide, malic acid dihydrazide, isophthalic acid dihydrazide, terephthalic acid dihydrazide, carbohydrazide, citric acid trihydrazide, pyromellitic acid trihydrazide, 1,2,4-benzenetrihydrazide, nitrilotriacetic acid trihydrazide, cyclohexanetricarboxylic acid trihydrazide, ethylenediaminetetraacetic acid tetrahydrazide, 1,4,5,8-naphthoic acid tetrahydrazide, a poly(acrylic acid hydrazide), and a poly(methacrylic acid hydrazide).

10: The mat of claim 1, wherein the agent capable of trapping formaldehyde is at least one selected from the group consisting of a mimosa, quebracho, pine, pecan nut, hemlock wood, and sumac tannin.

11: The mat of claim 1, wherein the agent capable of trapping formaldehyde is at least one selected from the group consisting of urea, 1,3-dimethylurea, ethyleneurea or its derivatives, diurea, biuret, triuret, acrylamide, methacrylamide, a polyacrylamide and a polymethacrylamide.

12: The mat of claim 1, wherein a content of the agent capable of trapping formaldehyde ranges from 0.1 to 500 g/m².

13: The mat of claim 1, further comprising a mineral filament or a mineral yarn, and optionally a fiber comprising a thermoplastic organic material.

14: The mat of claim 13, wherein the mineral yarn is a yarn comprising a plurality of mineral filaments, base yarns, or assemblies of base yarns in the form of rovings, commingled yarns comprising mineral filaments and filaments of organic material which are intimately mixed, or mixed yarns comprising a yarn comprising a plurality of mineral filaments and a yarn comprising a plurality of filaments of a thermoplastic organic material.

15: The mat of claim 13, wherein the mineral filament or the mineral yarn comprise glass.

16: The mat of claim 1, wherein a weight per unit area of the mat ranges from 10 to 1100 g/m².

17: A process for manufacturing the mat of claim 1, the process comprising:
forming filaments from a molten mineral material;
collecting the filaments in the form of a mat;
applying a binder to the mat;
passing the mat into a drying device; and
collecting the mat,
wherein the binder, the mat, or a combination thereof, is/are treated with the agent capable of trapping formaldehyde.

18: The process of claim 17, wherein the treatment comprises introducing the agent into the binder.

19: The process of claim 17, wherein the treatment comprises applying the agent to the mat after the applying of the binder to the mat and before the passing of the mat into the drying device.

20: The process of claim 19, wherein the applying of the agent occurs by spraying an aqueous solution of the agent.

21: A process for manufacturing the mat of claim 1, comprising:
depositing a dispersion of at least one cut mineral yarn in water with a forming head on a conveyor with perforations;
extracting the water with a suction box;
collecting the at least one mineral yarn in the form of a mat;
applying a binder to the mat;
passing the mat into a drying device; and
collecting the mat,
wherein the binder, the mat, or a combination thereof, is/are treated with the agent capable of trapping formaldehyde.

22: The process of claim 21, wherein the treatment comprises introducing the agent into the binder.

23: The process of claim 21, wherein the treatment comprises applying the agent to the mat after the applying of the binder to the mat and before the passing of the mat into the drying device.

24: The process of claim 23, wherein the applying the agent occurs by spraying an aqueous solution of the agent.
